(19) United States
(12) Patent Application Publication
(10) Pub. No.: US 2021/0321355 A1
(43) Pub. Date: Oct. 14, 2021

(54) TIMING ADJUSTMENT

(71) Applicant: NEC CORPORATION, Tokyo (JP)

(72) Inventors: Yukai GAO, Beijing (CN); Lin LIANG, Beijing (CN); Gang WANG, Beijing (CN)

(73) Assignee: NEC CORPORATION, Tokyo (JP)

(21) Appl. No.: 17/264,646

(22) PCT Filed: Aug. 3, 2018
(86) PCT No.: PCT/CN2018/098672

§ 371 Date: Jan. 29, 2021

(51) Int. Cl. H04W 56/00

(52) U.S. Cl. CPC H04W 56/0045; H04W 56/0055

(57) ABSTRACT

Embodiments of the present disclosure relate to methods, devices and computer readable mediums for timing adjustment. In example embodiments, a method implemented at a terminal device is provided. The method comprises, in response to a network device providing a serving cell to serve the terminal device and the serving cell being configured with at least a first procedure for adjusting timing of uplink transmissions and a second procedure for adjusting timing of uplink transmissions, determining, from the first and second procedures, at least one procedure to be applied to an uplink transmission. The method further comprises determining at least one timing advance (TA) value for the at least one procedure. In addition, the method further comprises applying the at least one procedure to the uplink transmission by adjusting the timing of the uplink transmission based on the at least one TA value.

### TECHNICAL FIELD

Embodiments of the present disclosure generally relate to the field of telecommunication, and in particular, to methods, devices and computer readable mediums for timing adjustment.

### BACKGROUND

Conventionally, an uplink (UL) transmission from a terminal device (for example, a user equipment (UE)) to a network device (for example, a next generation NodeB (gNB)) needs to be adjusted. The transmission of an UL radio frame from a terminal device should start a period of time before the start of a corresponding downlink (DL) radio frame, such that time of reception of UL signals from different terminal devices at the network device can be aligned to ensure UL orthogonality and reduce intra-cell interference. In new radio access (NR), if a terminal device is configured with two uplink carriers in a serving cell, a same value for timing advance adjustment may apply to both carriers. For example, upon reception of a timing advance command for a timing advance group (TAG) containing at least one serving cell from a network device (for example, a gNB), the terminal device shall adjust UL transmission timing for Physical Uplink Control Channel (PUCCH), Physical Uplink Shared Channel (PUSCH) and/or Sounding Reference Signal (SRS) of the at least one serving cell based on the received timing advance command.

However, in NR, the network device may be equipped with multiple Transmission and Reception Points (TRPs) or antenna panels. That is, UL signals can be transmitted from the terminal device to the network device via one or more of the multiple TRPs. Usually, for multi-TRP transmissions, the multiple TRPs can be within a same serving cell, but each of them may have a different distance from the terminal device. In this event, a same value for timing adjustment in a serving cell may not be sufficient for multi-TRP transmissions.

### SUMMARY

In general, example embodiments of the present disclosure provide methods, devices and computer readable mediums for timing adjustment.

In a first aspect, there is provided a method implemented at a terminal device. The method comprises, in response to a network device providing a serving cell to serve the terminal device and the serving cell being configured with at least a first procedure for adjusting timing of uplink transmissions and a second procedure for adjusting timing of uplink transmissions, determining, from the first and second procedures, at least one procedure to be applied to an uplink transmission. The method further comprises determining at least one timing advance (TA) value for the at least one procedure. In addition, the method further comprises applying the at least one procedure to the uplink transmission by adjusting the timing of the uplink transmission based on the at least one TA value.

In a second aspect, there is provided a method implemented at a network device. The method comprises, in response to the network device providing a serving cell to serve a terminal device and the serving cell being configured with at least a first procedure for adjusting timing of uplink transmissions and a second procedure for adjusting timing of uplink transmissions, determining, from the first and second procedures, at least one procedure to be applied to an uplink transmission. The method further comprises indicating the at least one procedure to the terminal device, such that the terminal device applies the at least one procedure to adjust timing of the uplink transmission.

In a third aspect, there is provided a device. The device comprises a processor and a memory coupled to the processor. The memory stores instructions that when executed by the processor, cause the device to perform actions. The actions include: in response to a network device providing a serving cell to serve the terminal device and the serving cell being configured with at least a first procedure for adjusting timing of uplink transmissions and a second procedure for adjusting timing of uplink transmissions, determining, from the first and second procedures, at least one procedure to be applied to an uplink transmission; determining at least one timing advance (TA) value for the at least one procedure; and applying the at least one procedure to the uplink transmission by adjusting the timing of the uplink transmission based on the at least one TA value.

In a fourth aspect, there is provided a device. The device comprises a processor and a memory coupled to the processor. The memory stores instructions that when executed by the processor, cause the device to perform actions. The actions include: in response to the network device providing a serving cell to serve a terminal device and the serving cell being configured with at least a first procedure for adjusting timing of uplink transmissions and a second procedure for adjusting timing of uplink transmissions, determining, from the first and second procedures, at least one procedure to be applied to an uplink transmission; and indicating the at least one procedure to the terminal device, such that the terminal device applies the at least one procedure to the uplink transmission.

In a fifth aspect, there is provided a computer readable medium having instructions stored thereon. The instructions, when executed on at least one processor, cause the at least one processor to carry out the method according to the first aspect of the present disclosure.

In a sixth aspect, there is provided a computer readable medium having instructions stored thereon. The instructions, when executed on at least one processor, cause the at least one processor to carry out the method according to the second aspect of the present disclosure.

In a seventh aspect, there is provided a computer program product that is tangibly stored on a computer readable storage medium. The computer program product includes instructions which, when executed on at least one processor, cause the at least one processor to carry out the method according to the first aspect or the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIGS. 1A-1B illustrate an example communication network in which embodiments of the present disclosure can be implemented;

FIG. 2 shows a flowchart of an example method for timing adjustment according to some embodiments of the present disclosure;

FIGS. 3A-3F show example information elements according to some embodiments of the present disclosure;

FIG. 4 shows an example of the association between different SRS resources and respective TA values according to some embodiments of the present disclosure;

FIGS. 5A-5C show examples of some embodiments of the present disclosure;

FIG. 6 shows an example of some embodiments of the present disclosure;

FIGS. 7A-7F show example information elements according to some embodiments of the present disclosure;

FIG. 8 shows an example of some embodiments of the present disclosure;

FIG. 9 shows a flowchart of an example method for timing adjustment according to some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As described above, an UL transmission from a terminal device (for example, a UE) to a network device (for example, a gNB) usually needs to be adjusted. The transmission of an UL radio frame from a terminal device should start a period of time before the start of a corresponding DL radio frame, such that time of reception of UL signals from different terminal devices at the network device can be aligned to ensure UL orthogonality and reduce intra-cell interference. In NR, if a terminal device is configured with two uplink carriers in a serving cell, a same value for timing advance adjustment may apply to both carriers. For example, upon reception of a timing advance command for a timing advance group containing at least one serving cell from a network device (for example, a gNB), the terminal device shall adjust UL transmission timing for PUCCH, PUSCH and/or SRS of the at least one serving cell based on the received timing advance command.

However, in NR, the network device may be equipped with multiple TRPs or antenna panels. That is, UL signals can be transmitted from the terminal device to the network device via one or more of the multiple TRPs. Usually, for multi-TRP transmissions, the multiple TRPs can be within a same serving cell, but each of them may have a different distance from the terminal device. In this event, a same value for timing adjustment in a serving cell may not be sufficient for multi-TRP transmissions.

Embodiments of the present disclosure provide a solution for timing adjustment, in order to solve the problems above and one or more of other potential problems. With the solution, different timing adjustments can be applied to different radio links in a cell. In particular, indication, measurement and application of a timing advance (TA) value for an individual radio link are enabled.

Principle and implementations of the present disclosure will be described in detail below with reference to the following figures.

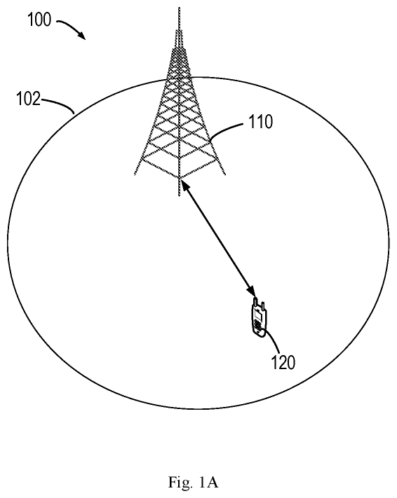

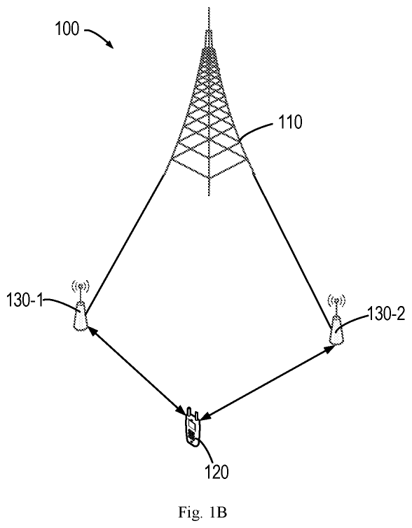

FIG. 1A shows an example communication network 100 in which embodiments of the present disclosure can be implemented. The network 100 includes a network device 110 and a terminal device 120 served by the network device 110. The network 100 may provide one or more serving cells 102 to serve the terminal device 120. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 220.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device 110.

For example, in some scenarios, carrier aggregation (CA) can be supported in the network 100, in which two or more component carriers (CCs) are aggregated in order to support a broader bandwidth. In CA, the network device 110 may provide a plurality of serving cells (for example, one for each of the CCs) including one primary cell (PCell) and at least one Secondary Cell (SCell) to serve the terminal device 120. The terminal device 120 can establish Radio Resource Control (RRC) connection with the network device 110 in the PCell. The SCell can provide additional radio resources once the RRC connection between the network device 110 and the terminal device 120 is established and the SCell is activated via higher layer signaling.

In some other scenarios, for example, the terminal device 120 may establish connections with two different network devices (not shown in FIG. 1A) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (SpCell)” may refer to the Pcell of the MCG or the primary Scell (PScell) of the SCG depending on if the terminal device 120 is associated to the MCG or the SCG, respectively. In other cases than the Dual Connectivity operation, the term “SpCell” may also refer to the PCell.

In the communication network 100 as shown in FIG. 1A, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

FIG. 1B shows an example scenario of the network 100 as shown in FIG. 1A. As shown in FIG. 1B, for example, the network device 110 may communicate with the terminal device 120 via the TRPs 130-1 and 130-2. In the following text, the TRP 130-1 may be also referred to as the first TRP, while the TRP 130-2 may be also referred to as the second TRP. The first and second TRPs 130-1 and 130-2 may be included in a same serving cell (such as, the cell 102 as shown in FIG. 1A) or different serving cells provided by the network device 110. Although some embodiments of the present disclosure are described with reference to the first and second TRPs 130-1 and 130-2 within a same serving cell provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

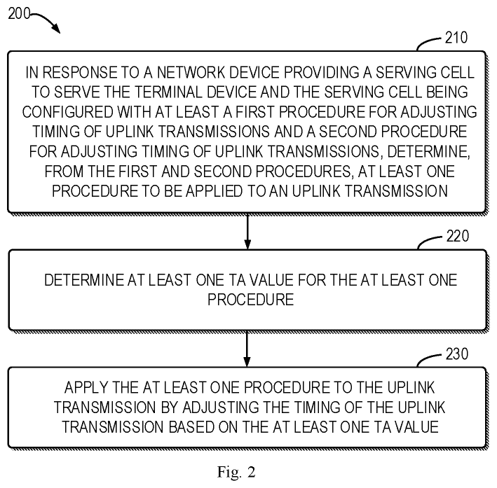

FIG. 2 shows a method 200 for timing adjustment according to some embodiments of the present disclosure. For example, the method 200 can be implemented at the terminal device 120 as shown in FIGS. 1A-1B. It is to be understood that the method 200 may include additional acts not shown and/or may omit some acts as shown, and the scope of the present disclosure is not limited in this regard. For the purpose of discussion, the method 200 will be described from the perspective of the terminal device 120 with reference to FIGS. 1A-1B.

At 210, in response to the network device 110 providing a serving cell 102 to serve the terminal device 120 and the serving cell 102 being configured with at least a first procedure for adjusting timing of uplink transmissions and a second procedure for adjusting timing of uplink transmissions, the terminal device 120 determines, from the first and second procedures, at least one procedure to be applied to an UL transmission.

In some embodiments, as shown in FIG. 1B, the network device 110 may be coupled with the first TRP 130-1 and the second TRP 130-2 for communication with the terminal device 120. For example, the first TRP 130-1 and the second TRP 130-2 may be included in the same serving cell 102. In some embodiments, for example, the first procedure associated with a first TA value may be configured for adjusting timing of uplink transmissions via the first TRP 130-1, while the second procedure associated with a second TA value may be configured for adjusting timing of uplink transmissions via the second TRP 130-2. In the following text, the first TA value may be represented as “T_{TA-1}”, and the second TA value may be represented as “T_{TA-2}”.

In some embodiments, for example, the first TA value T_{TA-1}for the first procedure may be the same as the TA value defined in current 3GPP specifications for one cell. In addition, for example, the second TA value T_{TA-2} for the second procedure may be an additional TA value for the cell. In some embodiments, the second TA value T_{TA-2} may be determined as an absolute value. Alternatively, in other embodiments, the second TA value T_{TA-2} may be determined as an offset with relative to the first TA value T_{TA-1}. The determination of the first and second TA values will be described in detail in the following.

In some embodiments, in response to receiving information on at least one resource associated with the uplink transmission, the terminal device 120 may select, from the first and second procedures configured for the serving cell and based on the information on the at least one resource, the at least one procedure to be applied to an UL transmission. For example, the at least one resource may include any of the following: one or more SRS resource sets to be used for SRS transmission, one or more SRS resources to be used for SRS transmission, one or more configurations about the spatial relation between a reference signal (RS) and the target SRS for SRS transmission, one or more SRS resources to be used for an uplink transmission over PUSCH, one or more DMRS ports to be used for DMRS transmission associated with PUSCH, one or more CSI-RS resources for determining pre-coding information to be used for SRS transmission, one or more CSI-RS resources associated with SRS resource(s) or SRS resource set for SRS transmission, one or more CSI-RS resources for determining pre-coding information to be used for an uplink transmission over PUSCH, one or more PUCCH resources to be used for an uplink transmission over PUCCH, one or more PUCCH resource sets to be used for an uplink transmission over PUCCH, one or more configurations about the spatial relation between a RS and the target PUCCH for PUCCH transmission, and so on.

In some embodiments, the at least one procedure to be applied to an UL transmission can be determined based on an indication of at least one SRS resource to be used for an uplink transmission over PUSCH. For example, in response to receiving from the network device 110 an indication of at least one SRS resource to be used for an UL transmission over PUSCH, the terminal device 120 may determine the at least one procedure to be applied to the uplink transmission over PUSCH based on the at least one SRS resource. In some embodiments, for codebook based UL transmissions or non-codebook based UL transmissions, an UL transmission over PUSCH may be scheduled by downlink control information (DCI) in format 0_1. For example, the DCI in format 0_1 may include an SRS resource indicator (SRI) field which indicates one or more SRS resources to be used for PUSCH transmissions. If a PUSCH transmission is scheduled by the DCI in format 0_1, the terminal device 120 may determine, based on the SRI from the DCI in format 0_1 received from the network device 110, that which one of the first and second procedures is to be applied to the PUSCH transmission.

In some embodiments, an additional filed can be introduced to an information element defining a SRS resource, indicating that which one of the first and second procedures is associated with the SRS resource. As such, once a SRS resource is configured to the terminal device 120, the terminal device 120 can determine, based on the additional field included in the information element indicating the SRS resource, that which one of the first and second TA values is to be used for adjusting the timing of an UL transmission associated with the SRS resource.

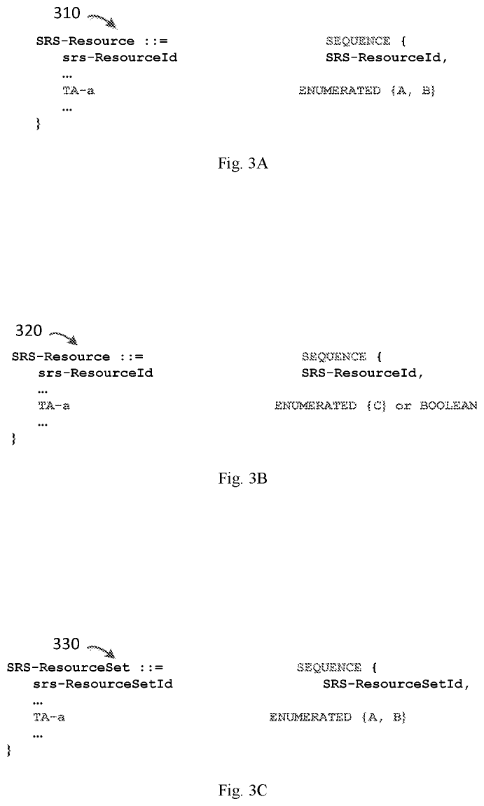

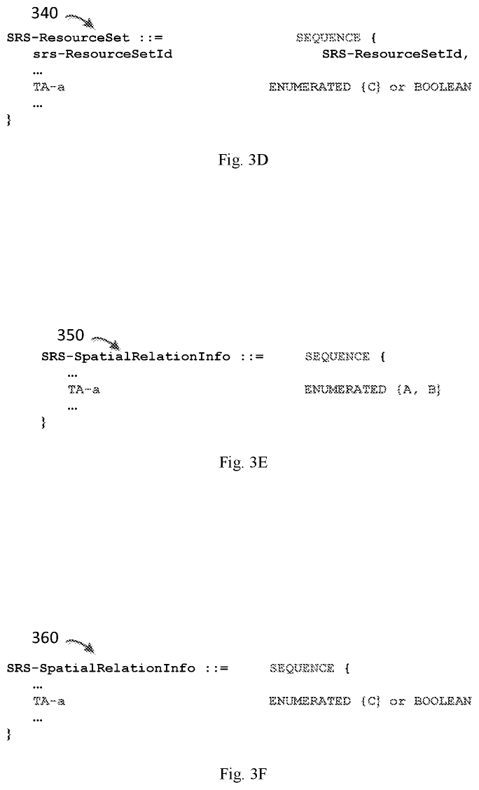

FIG. 3A shows an example of an information element 310 defining a SRS resource. As shown in FIG. 3A, an additional field “TA-a” is included in the information element 310, indicating the TA value associated with the SRS resource. For example, if the value of this field “TA-a” is ‘A’, it means that the first TA value T_{TA-1} is associated with the SRS resource. Otherwise, if the value of this field “TA-a” is ‘B’, it means that the second TA value T_{TA-2} is associated with the SRS resource. For example, (‘A’, ‘B’) may be (0, 1) or (enabled, disabled) or (present, absent) or (true, false). As another example, if the additional field “TA-a” is absent in the information element 310, it means that the first TA value T_{TA-1} is associated with the SRS resource.

FIG. 3B shows another example of an information element 320 defining a SRS resource. As shown in FIG. 3B, an additional filed “TA-a” may be introduced to the information element 320, indicating the TA value associated with the SRS resource. For example, if this field “TA-a” is absent in the information element 320 or the value of the field “TA-a” is “FALSE”, it means that the first TA value T_{TA-1} is associated with the SRS resource. Otherwise, if this field “TA-a” is present in the information element 320, or the value of the field “TA-a” is ‘C’ or “TRUE”, it means that the second TA value T_{TA-2} is associated with the SRS resource. For example, ‘C’ may be any value, such as, 0, 1, enabled, present or true.

FIG. 3C shows an example of an information element 330 defining a SRS resource set. As shown in FIG. 3C, an additional field “TA-a” is included in the information element 330, indicating the TA value associated with the SRS resource set. For example, if the value of this field “TA-a” is ‘A’, it means that the first TA value T_{TA-1} is associated with the SRS resource set. Otherwise, if the value of this field “TA-a” is ‘B’, it means that the second TA value T_{TA-2} is associated with the SRS resource set. For example, (‘A’, ‘B’) may be (0, 1) or (enabled, disabled) or (present, absent) or (true, false). As another example, if the additional field “TA-a” is absent in the information element 330, it means that the first TA value T_{TA-1} is associated with the SRS resource set.

FIG. 3D shows another example of an information element 340 defining a SRS resource set. As shown in FIG. 3D, an additional filed “TA-a” may be introduced to the information element 340, indicating the TA value associated with the SRS resource set. For example, if this field “TA-a” is absent in the information element 340 or the value of the field “TA-a” is “FALSE”, it means that the first TA value T_{TA-1} is associated with the SRS resource set. Otherwise, if this field “TA-a” is present in the information element 340, or the value of the field “TA-a” is ‘C’ or “TRUE”, it means that the second TA value T_{TA-2} is associated with the SRS resource set. For example, ‘C’ may be any value, such as, 0, 1, enabled, present or true.

FIG. 3E shows an example of an information element 350 defining a higher layer parameter “SRS-SpatialRelationInfo”. As shown in FIG. 3E, an additional field “TA-a” is included in the information element 350, indicating the TA value associated with the parameter “SRS-SpatialRelationInfo”. For example, if the value of this field “TA-a” is ‘A’, it means that the first TA value T_{TA-1} is associated with the parameter “SRS-SpatialRelationInfo”. Otherwise, if the value of this field “TA-a” is ‘B’, it means that the second TA value T_{TA-2} is associated with the parameter “SRS-SpatialRelationInfo”. For example, (‘A’, ‘B’) may be (0, 1) or (enabled, disabled) or (present, absent) or (true, false). As another example, if the additional field “TA-a” is absent in the information element 350, it means that the first TA value T_{TA-1} is associated with the parameter “SRS-SpatialRelationInfo”.

FIG. 3F shows another example of an information element 360 defining a higher layer parameter “SRS-SpatialRelationInfo”. As shown in FIG. 3F, an additional filed “TA-a” may be introduced to the information element 360, indicating the TA value associated with the parameter “SRS-SpatialRelationInfo”. For example, if this field “TA-a” is absent in the information element 360 or the value of the field “TA-a” is “FALSE”, it means that the first TA value T_{TA-1} is associated with the parameter “SRS-SpatialRelationInfo”. Otherwise, if this field “TA-a” is present in the information element 360, or the value of the field “TA-a” is ‘C’ or “TRUE”, it means that the second TA value T_{TA-2} is associated with the parameter “SRS-SpatialRelationInfo”. For example, ‘C’ may be any value, such as, 0, 1, enabled, present or true.

In some embodiments, two SRS resource sets/groups may be configured for the terminal device 120. Each SRS resource set/group may be associated with one respective CSI-RS resource. For example, the two SRS resource groups may be within one SRS resource set, and each SRS resource group may include at least one SRS resource. The SRS resources in different SRS resource groups may be different. In some embodiments, the terminal device 120 can calculate the pre-coder to be used for the transmission of the SRS resource group/set based on measurement of the associated CSI-RS resource.

In some embodiments, one SRS resource group/set may be associated with one respective CSI-RS resource. An additional field “TA-a” may be configured for a CSI-RS resource, and the field “TA-a” may indicate the TA value associated with the SRS resource group/set which is associated with the CSI-RS resource. For example, if the value of this field “TA-a” is ‘A’, it means that the first TA value T_{TA-1} is associated with the SRS resource group/set. Otherwise, if the value of this field “TA-a” is ‘B’, it means that the second TA value T_{TA-2} is associated with the SRS resource group/set. For example, (‘A’, ‘B’) may be (0, 1) or (enabled, disabled) or (present, absent) or (true, false). As another example, if the additional field “TA-a” is not configured for the CSI-RS resource, it means that the first TA value T_{TA-1} is associated with the SRS resource group/set.

In some embodiments, one SRS resource group/set may be associated with one respective CSI-RS resource. An additional field “TA-a” may be configured for a CSI-RS resource, and the field “TA-a” may indicate the TA value associated with the SRS resource group/set which is associated with the CSI-RS resource. For example, if this field “TA-a” is not configured for the CSI-RS resource or the value of the field “TA-a” configured for the CSI-RS resource is “FALSE”, it means that the first TA value T_{TA-1} is associated with the SRS resource group/set. Otherwise, if this field “TA-a” is configured for the CSI-RS resource, or the value of the field “TA-a” configured for the CSI-RS resource is ‘C’ or “TRUE”, it means that the second TA value T_{TA-2} is associated with the SRS resource group/set. For example, ‘C’ may be any value, such as, 0, 1, enabled, present or true.

In some embodiments, one or two SRS resource sets/groups may be configured for the terminal device 120. Each SRS resource set/group may be associated with two CSI-RS resources. For example, the two SRS resource groups may be within one SRS resource set, and each SRS resource group may include at least one SRS resource. The SRS resources in different SRS resource groups may be different. In some embodiments, the terminal device 120 may select one from the two associated CSI-RS resources, and calculate the pre-coder to be used for the transmission of the SRS resource group/set based on measurement of the selected associated CSI-RS resource.

In some embodiments, one SRS resource group/set may be associated with one or two CSI-RS resources. In some embodiments, the TA value associated with the SRS resource group/set may be determined based on a selected CSI-RS resource. For example, suppose that two CSI-RS resources are associated with the SRS resource group/set, including first and second CSI-RS resources. If the terminal device 120 selects the first CSI-RS resource, it means that the first TA value T_{TA-1} is associated with the SRS resource group/set. Otherwise, if the terminal device selects the second CSI-RS resource, it means that the second TA value T_{TA-2} is associated with the SRS resource group/set. For another example, if only one CSI-RS resource is configured to be associated with the SRS resource group/set, it means that the first TA value T_{TA-1} is associated with the SRS resource group/set.

In some embodiments, one SRS resource group/set may be associated with one or two CSI-RS resources. An additional field “TA-a” may be configured for a CSI-RS resource, and the field “TA-a” may indicate the TA value associated with the SRS resource group/set which is associated with the CSI-RS resource. In some embodiments, the TA value associated with the SRS resource group/set may be determined based on a selected CSI-RS resource. For example, if the terminal device 120 selects one of the two CSI-RS resources, and if the value of this field “TA-a” is ‘A’, it means that the first TA value T_{TA-1} is associated with the SRS resource group/set. Otherwise, if the value of this field “TA-a” is ‘B’, it means that the second TA value T_{TA-2} is associated with the SRS resource group/set. For example, (‘A’, ‘B’) may be (0, 1) or (enabled, disabled) or (present, absent) or (true, false). As another example, if the additional field “TA-a” is not configured for the CSI-RS resource, it means that the first TA value T_{TA-1} is associated with the SRS resource group/set.

In some embodiments, one SRS resource group/set may be associated with one or two CSI-RS resources. An additional field “TA-a” may be configured for a CSI-RS resource, and the field “TA-a” may indicate the TA value associated with the SRS resource group/set which is associated with the CSI-RS resource. In some embodiments, the TA value associated with the SRS resource group/set may be determined based on a selected CSI-RS resource. For example, if this field “TA-a” is not configured for the CSI-RS resource or the value of the field “TA-a” configured for the CSI-RS resource is “FALSE”, it means that the first TA value T_{TA-1} is associated with the SRS resource group/set. Otherwise, if this field “TA-a” is configured for the CSI-RS resource, or the value of the field “TA-a” configured for the CSI-RS resource is ‘C’ or “TRUE” it means that the second TA value T_{TA-2} is associated with the SRS resource group/set. For example, ‘C’ may be any value, such as, 0, 1, enabled, present or true.

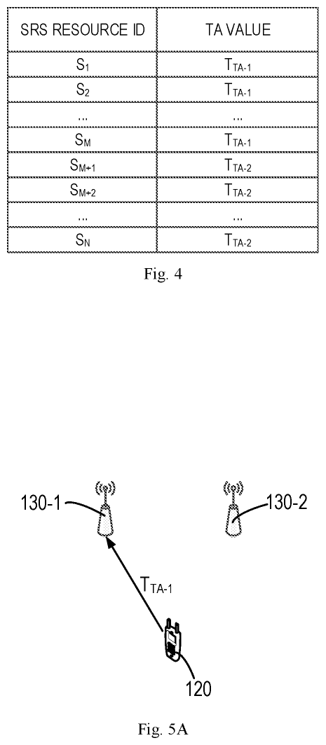

FIG. 4 shows an example of such association between different SRS resources and respective TA values according to some embodiments of the present disclosure. As shown in FIG. 4, a first group of SRS resources {S₁, S₂ . . . S_{M}} may be associated with the first TA value T_{TA-1}, while a second group of SRS resources {S_{M+1}, S_{M+2} . . . S_{N}} may be associated with the second TA value T_{TA-2}, where M and N are both integers and N>M, and Sᵢ (where I is an integer and 1≤i≤N) represents an identifier of a SRS resource.

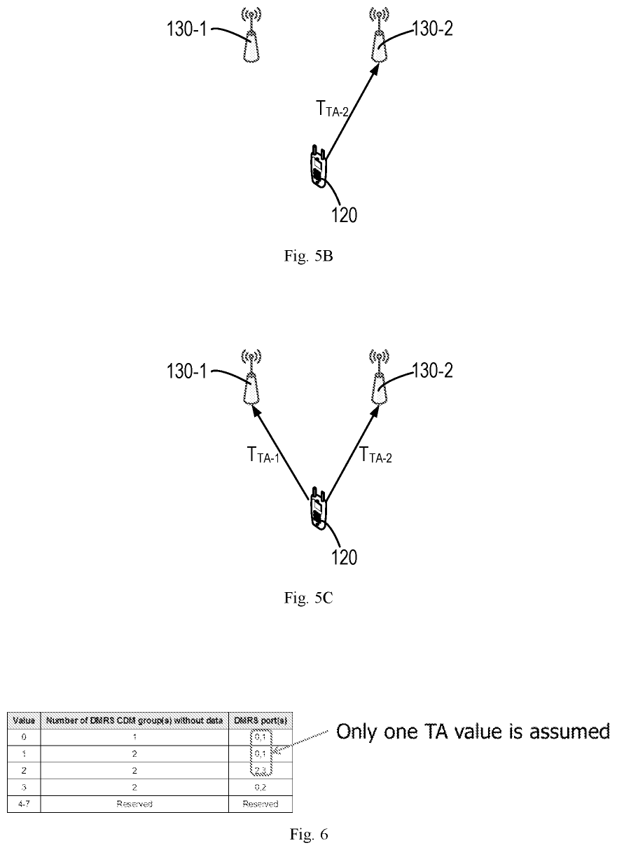

In some embodiments, if the SRS resources indicated by the SRI field are associated with a same TA value (for example, T_{TA-1} or T_{TA-2}), the timing of uplink transmissions over these SRS resources may be adjusted based on the same TA value. As described above, the first TA value T_{TA-1} may be configured for adjusting timing of uplink transmissions via the first TRP 130-1, while the second TA value T_{TA-2} may be configured for adjusting timing of uplink transmissions via the second TRP 130-2. For example, if all of the SRS resources indicated by the SRI field are included in the first group of SRS resources {S₁, S₂ . . . S_{M}}, these SRS resources indicated by the SRI field may be used for uplink transmissions via the first TRP 130-1. In this event, the timing of the uplink transmissions over these SRS resources via the first TRP 130-1 can be adjusted based on the first TA value T_{TA-1}. FIG. 5A shows an example of such embodiments. Alternatively, if all of the SRS resources indicated by the SRI field are included in the second group of SRS resources {S_{M+1}, S_{M+2} . . . S_{N}}, these SRS resources indicated by the SRI field may be used for uplink transmissions via the second TRP 130-2. In this event, the timing of the uplink transmissions over these SRS resources via the second TRP 130-2 can be adjusted based on the second TA value T_{TA-2}. FIG. 5B shows an example of such embodiments.

In some embodiments, if the SRS resources indicated by the SRI field are associated with different TA values (for example, some SRS resources are associated with the first TA value T_{TA-1} and others are associated with the second TA value T_{TA-2}), the timing of uplink transmissions over these SRS resources may be adjusted based on the different TA values respectively. As described above, the first TA value T_{TA-1} may be configured for adjusting the timing of uplink transmissions via the first TRP 130-1, while the second TA value T_{TA-2} may be configured for adjusting the timing of uplink transmissions via the second TRP 130-2. For example, if the SRS resources indicated by the SRI field include a first SRS resource included in the first group of SRS resources {S₁, S₂ . . . S_{M}} and a second SRS resource included in the second group of SRS resources {S_{M+1}, S_{M+2} . . . S_{N}}, the first SRS resource may be used for an uplink transmission via the first TRP 130-1 while the second SRS resource may be used for an uplink transmission via the second TRP 130-2. In this event, the timing of the uplink transmission over the first SRS resource via the first TRP 130-1 can be adjusted based on the first TA value T_{TA-1}, while the timing of the uplink transmission over the second SRS resource via the second TRP 130-2 can be adjusted based on the second TA value T_{TA-2}. FIG. 5C shows an example of such embodiments.

In some embodiments, the at least one procedure to be applied to an UL transmission can be determined based on an indication of at least one SRS resource to be used for an uplink transmission over PUSCH. For example, in response to receiving from the network device 110 an indication of at least one DMRS port to be used for transmitting a DMRS associated with PUSCH, the terminal device 120 may determine the at least one procedure to be applied to an uplink transmission over PUSCH based on the at least one DMRS port. For example, a plurality of DMRS ports multiplexed based on Code Division Multiplexing (CDM) technology may be configured to the terminal device 120 for transmitting DMRSs associated with PUSCH, and the plurality of DMRS ports may be associated with only one TRP. In this event, the terminal device 120 may not expect to be configured with the SRI indicating different TA values simultaneously. For example, in this event, if both of the first and second TA values T_{TA-1} and T_{TA-2} are indicated by the SRI received from the network device 110, only the first TA value T_{TA-1} may be used for adjusting the timing of uplink transmissions, while the second TA value T_{TA-2} may be ignored. FIG. 6 shows an example of such embodiments. As shown in FIG. 6, DMRS ports {0, 1} may be associated with a same TRP, and thus only one TA value should be assumed by the terminal device 120. DMRS ports {2, 3} may also be associated with a same TRP, and thus only one TA value may be assumed by the terminal device 120.

In some embodiments, for non-codebook based UL transmissions, the terminal device 120 may determine a pre-coder to be used for UL transmissions based on measurement of an associated Channel State Information-Reference Signal (CSI-RS). Once determining the pre-coder to be used for UL transmissions, the terminal device 120 may transmit a pre-coded SRS to the network device 110 over a SRS resource set configured for SRS transmissions. The SRS can be received and used by the network device 110 to perform uplink channel estimation, so as to perform resource allocation and configure transmission parameters for UL transmissions (for example, PUSCH transmissions) based on the result of the uplink channel estimation. In this case, the at least one procedure to be applied to an UL transmission can be determined based on an indication of at least one CSI-RS resource for calculating the pre-coder. For example, in response to receiving from the network device 110 an indication of an indication of at least one CSI-RS resource for determining pre-coding information to be used for an uplink transmission over PUSCH, the terminal device 120 may determine the at least one procedure to be applied to the uplink transmission over PUSCH based on the at least one CSI-RS resource. Then, the corresponding TA value associated with the at least one procedure can be used for adjusting the timing of the uplink transmission of the pre-coded SRS associated with the at least one CSI-RS resource.

In some embodiments, the at least one procedure to be applied to an UL transmission can be determined based on a PUCCH configuration. For example, If an uplink transmission over PUSCH is triggered by DCI in DCI format 0_0, and if the terminal device 120 is provided with a spatial setting by a higher layer parameter “PUCCH-Spatialrelationinfo” for a PUCCH resource with a lowest index within the active UL bandwidth part (BWP) of the serving cell, the terminal device 120 may perform the uplink transmission over PUSCH based on the PUCCH resource. In this case, the terminal device 120 may determine, from the first and second procedures, a third procedure to be applied to the uplink transmission over PUSCH based on the PUCCH resource with a lowest index within the active UL bandwidth part (BWP) of the serving cell. For example, the terminal device 120 may determine one of the first and second TA values to be applied to the uplink transmission over PUSCH based on the PUCCH resource with a lowest index within the active UL bandwidth part (BWP) of the serving cell. Additionally, regarding an uplink transmission over PUCCH, the terminal device 120 may determine, from the first and second procedures, a fourth procedure to be applied to an uplink transmission over PUCCH based on a PUCCH resource to be used for the uplink transmission over PUCCH. For example, the terminal device 120 may determine one of the first and second TA values to be applied to an uplink transmission over PUCCH based on a PUCCH resource to be used for the uplink transmission over PUCCH.

In some embodiment, an additional filed can be introduced to an information element defining the higher layer parameter “PUCCH-Spatialrelationinfo” , indicating that which one of the first and second TA values is to be used for timing adjustment. As such, once the higher layer parameter “PUCCH-Spatialrelationinfo” is configured to the terminal device 120, the terminal device 120 can determine, based on the additional field included in the higher layer parameter “PUCCH-Spatialrelationinfo” , that which one of the first and second TA values is to be used for timing adjustment.

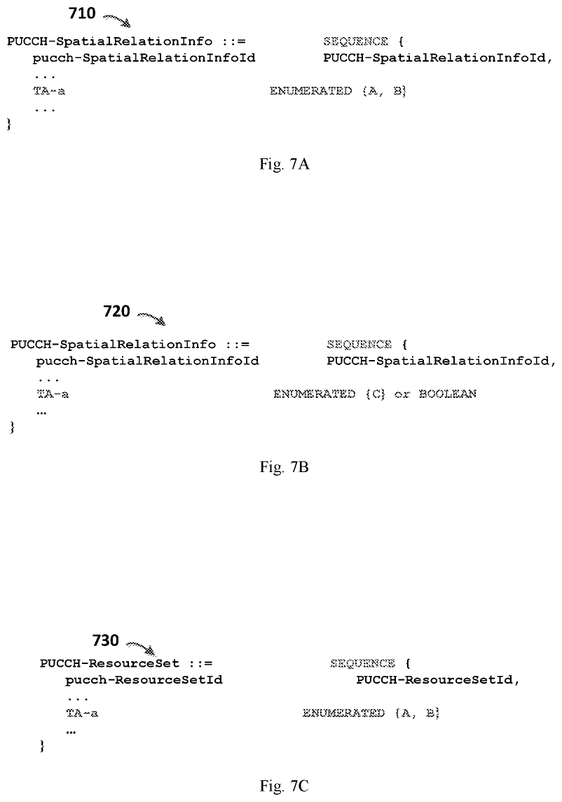

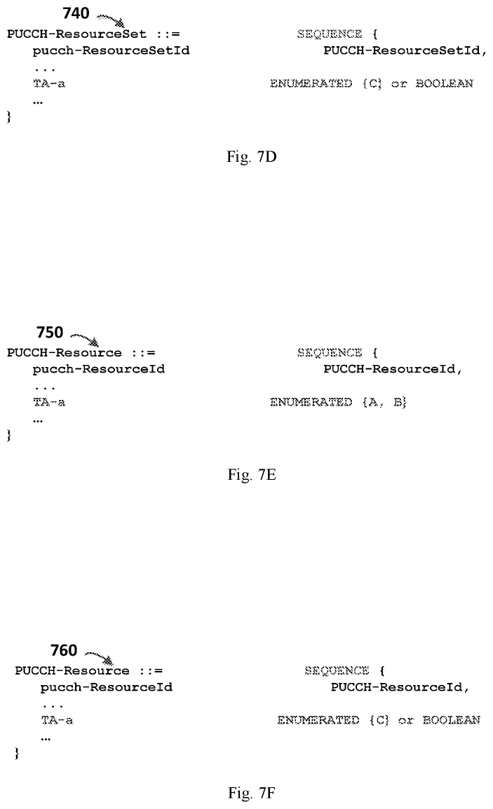

FIG. 7A shows an example of an information element 710 defining the higher layer parameter “PUCCH-Spatialrelationinfo” . As shown in FIG. 7A, an additional field “TA-a” is included in the information element 710, indicating which one of the first and second TA values is to be used for timing adjustment. For example, if the value of this field “TA-a” is ‘A’, it means that the first TA value T_{TA-1} is to be used for timing adjustment. Otherwise, if the value of this field “TA-a” is ‘B’, it means that the second TA value T_{TA-2} is to be used for timing adjustment. For example, (‘A’, ‘B’) may be (0, 1) or (enabled, disabled) or (present, absent) or (true, false). As another example, if the additional field “TA-a” is absent in the information element 710, it means that the first TA value T_{TA-1} is to be used for timing adjustment.

FIG. 7B shows another example of an information element 720 defining the higher layer parameter “PUCCH-Spatialrelationinfo”. As shown in FIG. 7B, an additional filed “TA-a” may be introduced to the information element 720, indicating which one of the first and second TA values is to be used for timing adjustment. For example, if this field “TA-a” is absent in the information element 720 or the value of the field “TA-a” is “FALSE”, it means that the first TA value T_{TA-1} is to be used for timing adjustment. Otherwise, if this field “TA-a” is present in the information element 720, or the value of the field “TA-a” is ‘C’ or “TRUE”, it means that the second TA value T_{TA-2} is to be used for timing adjustment.

For example, ‘C’ may be any value, such as, 0, 1, enabled, present or true.

FIG. 7C shows an example of an information element 730 defining a higher layer parameter “PUCCH-ResourceSet” . As shown in FIG. 7C, an additional field “TA-a” is included in the information element 730, indicating which one of the first and second TA values is to be used for timing adjustment. For example, if the value of this field “TA-a” is ‘A’, it means that the first TA value T_{TA-1} is to be used for timing adjustment. Otherwise, if the value of this field “TA-a” is ‘B’, it means that the second TA value T_{TA-2} is to be used for timing adjustment. For example, (‘A’, ‘B’) may be (0, 1) or (enabled, disabled) or (present, absent) or (true, false). As another example, if the additional field “TA-a” is absent in the information element 730, it means that the first TA value T_{TA-1} is to be used for timing adjustment.

FIG. 7D shows another example of an information element 740 defining the higher layer parameter “PUCCH-ResourceSet” . As shown in FIG. 7D, an additional filed “TA-a” may be introduced to the information element 740, indicating which one of the first and second TA values is to be used for timing adjustment. For example, if this field “TA-a” is absentin the information element 740 or the value of the field “TA-a” is “FALSE”, it means that the first TA value T_{TA-1} is to be used for timing adjustment. Otherwise, if this field “TA-a” is present in the information element 740, or the value of the field “TA-a” is ‘C’ or “TRUE”, it means that the second TA value T_{TA-2} is to be used for timing adjustment. For example, ‘C’ may be any value, such as, 0, 1, enabled, present or true.

FIG. 7E shows an example of an information element 750 defining a higher layer parameter “PUCCH-Resource” . As shown in FIG. 7E, an additional field “TA-a” is included in the information element 750, indicating which one of the first and second TA values is to be used for timing adjustment. For example, if the value of this field “TA-a” is ‘A’, it means that the first TA value T_{TA-1} is to be used for timing adjustment. Otherwise, if the value of this field “TA-a” is ‘B’, it means that the second TA value T_{TA-2} is to be used for timing adjustment. For example, (‘A’, ‘B’) may be (0, 1) or (enabled, disabled) or (present, absent) or (true, false). As another example, if the additional field “TA-a” is absent in the information element 750, it means that the first TA value T_{TA-1} is to be used for timing adjustment.

FIG. 7F shows another example of an information element 760 defining the higher layer parameter“PUCCH-Resource”. As shown in FIG. 7F, an additional filed “TA-a” may be introduced to the information element 760, indicating which one of the first and second TA values is to be used for timing adjustment. For example, if this field “TA-a” is absent in the information element 760 or the value of the field “TA-a” is “FALSE”, it means that the first TA value T_{TA-1} is to be used for timing adjustment. Otherwise, if this field “TA-a” is present in the information element 760, or the value of the field “TA-a” is ‘C’ or “TRUE”, it means that the second TA value T_{TA-2} is to be used for timing adjustment. For example, ‘C’ may be any value, such as, 0, 1, enabled, present or true.

In some embodiments, the at least one procedure to be applied to an UL transmission can be determined based on a PDCCH order, which can also be used to trigger a random access procedure. For example, one additional bit can be introduced to the PDCCH order, indicating that which one of the first and second procedures is to be applied.

Alternatively, or in addition, in some embodiments, synchronization signal block (SSB) indexes and/or CSI-RS resources (or resource sets) can be divided into different groups, each of which may correspond to a respective timing adjustment within the cell. As such, a group of SSB indexes and/or CSI-RS resources can implicitly indicate a respective TA value. Alternatively, or in addition, in some embodiments, two TAG identities (TAG-IDs) can be configured for one cell, each of which may correspond to a respective timing adjustment within the cell. As such, a TAG-ID can implicitly indicate a respective TA value.

With reference back to FIG. 2, at 220, the terminal device 120 determines at least one TA value for the at least one procedure. Then, at 230, the terminal device 120 applies the at least one procedure to the uplink transmission by adjusting the timing of the uplink transmission based on the determined at least one TA value.

In some embodiments, if the first procedure is determined to be applied to a first UL transmission via the first TRP 130-1, the terminal device 120 may calculate the first TA value T_{TA-1}. Then, the terminal device 120 may adjust the timing of the first UL transmission based on the first TA value T_{TA-1}. Alternatively, or in addition, in some embodiments, if the second procedure is determined to be applied to a second UL transmission via the second TRP 130-2, the terminal device 120 may calculate the second TA value T_{TA-2}. Then, the terminal device 120 may adjust the timing of the second UL transmission based on the second TA value T_{TA-2}.

In some embodiments, for example for multi-TRP transmissions, two different procedures for TA measurement and adjustment can be supported in one cell. For example, the first procedure can be used for determining the first TA value T_{TA-1} and timing adjustment based on the first TA value T_{TA-1}, and the second procedure can be used for determining the second TA value T_{TA-2} and timing adjustment based on the second TA value T_{TA-2}. For example, the first TA value T_{TA-1} can be determined based on at least one of the following: a TA command from a Random Access Response; a TA command from a Medium Access Control (MAC) Control Element (CE); and a TA value determined for the first procedure previously. For example, the second TA value T_{TA-2} can be determined based on at least one of the following: a TA command from a Random Access Response; a TA command from a MAC CE; a TA value determined for the first procedure previously; a TA value determined for the second procedure previously; and a timing difference between a first downlink signal received from the first TRP 130-1 and a second downlink signal received from the second TRP 130-2.

In some embodiments, if the first TA value T_{TA-1} associated with the first procedure is determined to be applied, the first procedure for determining the first TA value T_{TA-1} and timing adjustment based on the first TA value T_{TA-1} can be performed by the terminal device 120. In some embodiments, in response to receiving a Random Access Response (RAR) including a timing advance command (such as, 12 bits) from the network device 110, the terminal device 120 may determine the first TA value T_{TA-1} based on the timing advance command included in the RAR as the following equation (1):

T_{TA-1}=T_{A-1}·16·64/2^{μ} (1)

where T_{A-1} represents an index value indicated by the 12-bit timing advance command for controlling the amount of the first procedure to be applied. For example, μ is an integer and μ>0.

Alternatively, in some other embodiments, in response to receiving a MAC CE including a timing advance command (such as, 6 bits) from the network device 110, the terminal device 120 may determine the first TA value T_{TA-1} based on the timing advance command included in the MAC CE (also referred to as “TA command MAC CE” in the following text) as the following equation (2):

T_{TA-1_new}=T_{TA-1_old}+(T_{TA-1}−31)·16·64/2^{μ} (2)

where T_{TA-1} represents an index value indicated by indicated by the 6-bit timing advance command in the MAC CE for controlling the amount of the first procedure to be applied. T_{TA-1_old} represents the first TA value T_{TA-1} determined last time in the first procedure and T_{TA-1_new} represents the first TA value T_{TA-1} to be determined this time. For example, μ is an integer and μ>0.

In some embodiments, if the second TA value T_{TA-2} associated with the second procedure is determined to be applied, the second procedure for determining the second TA value T_{TA-2} and timing adjustment based on the second TA value T_{TA-2} can be performed by the terminal device 120. In some embodiments, for an initial TA adjustment in the second procedure, the second TA value T_{TA-2} can be determined based on the timing advance command included in the RAR or the timing advance command included in the MAC CE. For example, in some embodiments, for the initial TA adjustment in the second procedure, in response to receiving a Random Access Response (RAR) including a timing advance command (such as, 12 bits) from the network device 110, the terminal device 120 may determine the second TA value T_{TA-2} based on the timing advance command included in the RAR as the following equation (3):

T_{TA-2}=T_{A-2}·16·64/2^{μ} (3)

where T_{A-2} represents an index value indicated by the 12-bit timing advance command for controlling the amount of the second procedure to be applied. For example, μ is an integer and μ>0.

Alternatively, in some other embodiments, in response to receiving a MAC CE including a timing advance command (such as, 6 bits) from the network device 110, the terminal device 120 may determine the second TA value T_{TA-2} based on the timing advance command included in the MAC CE as the following equation (4):

T_{TA-2}=T_{TA_old}+(T_{A-2}−31)·16·64/2μ (4)

where T_{A-2} represents an index value indicated by indicated by the 6-bit timing advance command in the MAC CE for controlling the amount of the second procedure to be applied, and T_{TA_old} represents the latest TA value determined in the first procedure. For example, μ is an integer and μ>0.

In some embodiments, for a subsequent TA adjustment in the second procedure, the second TA value T_{TA-2} can be determined based on the timing advance command included in the MAC CE. In some other embodiments, in response to receiving a MAC CE including a timing advance command (such as, 6 bits) from the network device 110, the terminal device 120 may determine the second TA value T_{TA-2} based on the timing advance command included in the MAC CE as the following equation (5):

T_{TA-2_new}=T_{TA-2_old}+(T_{A-2}−31)·16·64/2^{μ} (5)

where T_{A-2} represents an index value indicated by indicated by the 6-bit timing advance command in the MAC CE for controlling the amount of the second procedure to be applied. T_{TA-2_old} represents the second TA value T_{TA-2} determined last time in the second procedure and T_{TA-2_new} represents the second TA value T_{TA-2} to be determined this time. For example, μ is an integer and μ>0. Alternatively, in some other embodiments, in response to receiving a MAC CE including a timing advance command (such as, 6 bits) from the network device 110, the terminal device 120 may determine the second TA value T_{TA-2} based on the timing advance command included in the MAC CE as the following equation (6):

T_{TA-2}=T_{TA_old}+(T_{A-2}−31)·16·64/2^{μ} (6)

where T_{A-2} represents an index value indicated by indicated by the 6-bit timing advance command in the MAC CE for controlling the amount of the second procedure to be applied, and T_{TA_old} represents the latest TA value determined in the first procedure. For example, μ is an integer and μ>0.

In some embodiments, for example for multi-TRP transmissions, two different procedures for TA measurement and adjustment can be supported in one cell. For example, the first procedure may be used for determining the first TA value T_{TA-1} and timing adjustment based on the first TA value T_{TA-1}, and the second procedure may be used determining the second TA value T_{TA-2} and timing adjustment based on the second TA value T_{TA-2}.

In some embodiments, if the first TA value T_{TA-1} associated with the first procedure is determined to be applied, the first procedure for determining the first TA value T_{TA-1} and timing adjustment based on the first TA value T_{TA-1} can be performed by the terminal device 120. In some embodiments, in response to receiving a Random Access Response (RAR) including a timing advance command (such as, 12 bits) from the network device 110, the terminal device 120 may determine the first TA value T_{TA-1} based on the timing advance command included in the RAR as the above equation (1). Alternatively, in some other embodiments, in response to receiving a MAC CE including a timing advance command (such as, 6 bits) from the network device 110, the terminal device 120 may determine the first TA value T_{TA-1} based on the timing advance command included in the MAC CE as the above equation (2).

In some embodiments, if the second TA value T_{TA-2} associated with the second procedure is determined to be applied, the second procedure for determining the second TA value T_{TA-2} and timing adjustment based on the second TA value T_{TA-2} can be performed by the terminal device 120. In some embodiments, the second TA value T_{TA-2} can be determined by the terminal device 120 autonomously. For example, the terminal device 120 may measure a timing difference between a first downlink signal received from the first TRP 130-1 and a second downlink signal received from the second TRP 130-2. Each of the first and second DL signals may be a DL reference signal (RS) or SSB. The terminal device 120 may further determine the second TA value T_{TA-2} based on the determined timing difference between the two DL signals and the latest TA value determined in the first procedure as the following equation (7):

T_{TA-2}=T_{TA_old}+2·ΔT_{A}·16·64/2^{μ} (7)

where ΔT_{A} represents the determined timing difference between the two DL signals and T_{TA_old} represents the latest TA value determined in the first procedure. For example, μ is an integer and μ>0.

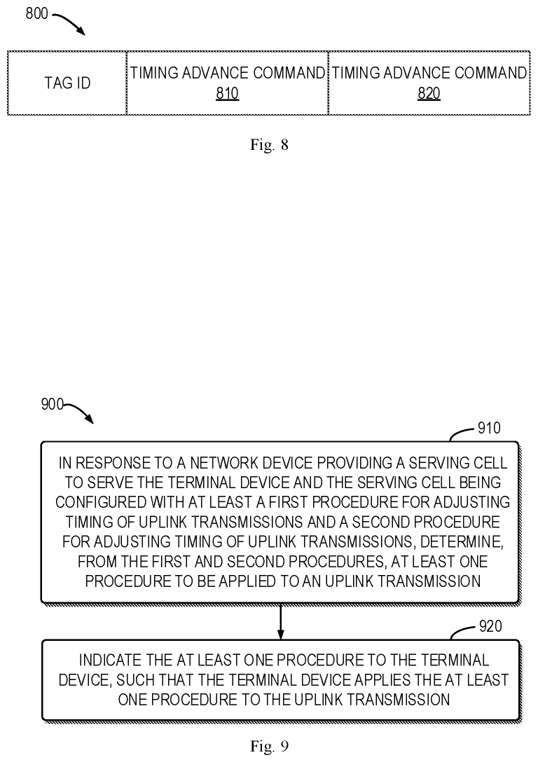

In some embodiments, for example for multi-TRP transmissions, two different procedures for TA measurement and adjustment can be supported in one cell. For example, the first procedure may be used for determining the first TA value T_{TA-1} and timing adjustment based on the first TA value T_{TA-1}, and the second procedure may be used for determining the second TA value T_{TA-2} and timing adjustment based on the second TA value T_{TA-2}. In some embodiments, the TA command MAC CE transmitted from the network device 110 to the terminal device 120 may include two individual TA commands, each corresponding to one of the two different procedures. FIG. 8 shows an example of the TA command MAC CE 800. As shown in FIG. 8, the MAC CE 800 may include a timing advance command 810 and a timing advance command 820. The timing advance command 810 may be associated with the first procedure, indicating an index value used to control the amount of the first procedure. The timing advance command 820 may be associated with the second procedure, indicating an index value used to control the amount of the second procedure. In some embodiments, if the terminal device 120 configured with different TA values in one cell does not receive the MAC CE 800, the terminal device 120 may adjust the timing of uplink transmission based on the first TA value T_{TA-1} determined in the first procedure.

In some embodiments, to adjust the timing of an uplink transmission, the transmission of an UL radio frame from the terminal device 120 should start a period of time (which is indicated by a respective TA value) before the start of a corresponding DL radio frame. In some embodiments, if multiple TA procedures are supported, the position of the corresponding DL radio frame may be based on the timing estimated from a corresponding DL RS. Examples of the corresponding DL RS may include but not limited to a DL RS for path loss estimation or a quasi-co-locationed (QCLed) DL RS.

In some embodiments, the first TRP 130-1 and the second TRP 130-2 may belong to different cells (such as, associated with different cell indexes respectively). In this case, one TA procedure and one TA value may be sufficient for each cell. However, in this case, to support joint transmissions, DCI should indicate both of serving cell scheduling and cross-cell scheduling. In some embodiments, for example, one additional bit may be introduced to DCI format 0_1 or DCI format 1_1 to indicate whether two cells are scheduled in the same DCI.

FIG. 9 shows a flowchart of an example method 900 in accordance with some embodiments of the present disclosure. The method 900 can be implemented at the network device 110 as shown in FIG. 1A. It is to be understood that the method 900 may include additional acts not shown and/or may omit some acts as shown, and the scope of the present disclosure is not limited in this regard. For the purpose of discussion, the method 900 will be described from the perspective of the network device 110 with reference to FIG. 1A.

At 910, in response to the network device 110 providing a serving cell 102 to serve a terminal device 120 and the serving cell 102 being configured with at least a first procedure for adjusting timing of uplink transmissions and a second procedure for adjusting timing of uplink transmissions, determining, from the first and second procedures, at least one procedure to be applied to an uplink transmission.

At 920, the network device 110 indicates the at least one procedure to the terminal device 120, such that the terminal device 120 applies the at least one procedure to the uplink transmission.

In some embodiments, the network device is coupled with a first TRP 130-1 and a second TRP 130-2 for communication with the terminal device, the first and second TRPs 130-1 and 130-2 being included in the serving cell 102. In some embodiments, the first procedure is configured for adjusting timing of uplink transmissions via the first TRP 130-1 and the second procedure is configured for adjusting timing of uplink transmissions via the second TRP 130-2.

In some embodiments, the network device 110 may indicate the at least one procedure by transmitting, to the terminal device 120, information on at least one resource associated with the uplink transmission.

In some embodiments, the network device 110 may determine at least one procedure to be applied to an uplink transmission over PUSCH. The network device 110 may indicate the at least one procedure by transmitting, to the terminal device, an indication of at least one SRS resource to be used for the uplink transmission over PUSCH.

In some embodiments, the network device 110 may determine at least one procedure to be applied to an uplink transmission over PUSCH. The network device 110 may indicate the at least one procedure by transmitting, to the terminal device 120, an indication of at least one DMRS port to be used for transmitting a DMRS associated with PUSCH.

In some embodiments, the network device 110 may determine at least one procedure to be applied to an uplink transmission over PUSCH. The network device 110 may indicate the at least one procedure by transmitting, to the terminal device 120, an indication of at least one CSI-RS resource for determining pre-coding information to be used for the uplink transmission over PUSCH.

In some embodiments, the network device 110 may determine a third procedure to be applied to an uplink transmission over PUSCH and a fourth procedure to be applied to an uplink transmission over PUCCH. The network device 110 may indicate the at least one procedure by transmitting, to the terminal device 120, a configuration for transmissions over PUCCH.

In some embodiments, the network device 110 may transmit a first TA command indicating a first TA value for the first procedure and a second TA command indicating a second TA value for the second procedure to the terminal device, such that the terminal device 120 applies the at least one procedure to the uplink transmission by adjusting the timing of the uplink transmission based on at least one of the first and second TA values.

In some embodiments, the first and second TA commands are transmitted via at least one of a RAR and a MAC CE.

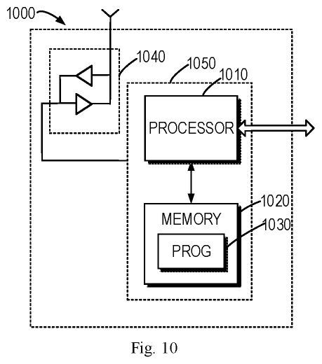

FIG. 10 is a simplified block diagram of a device 1000 that is suitable for implementing embodiments of the present disclosure. The device 1000 can be considered as a further example implementation of the network device 110 or the terminal device 120 as shown in FIGS. 1A-1B. Accordingly, the device 1000 can be implemented at or as at least a part of the network device 110 or the terminal device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 and 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method implemented at a terminal device, comprising:
in response to a network device providing a serving cell to serve the terminal device and the serving cell being configured with at least a first procedure for adjusting timing of uplink transmissions and a second procedure for adjusting timing of uplink transmissions, determining, from the first and second procedures, at least one procedure to be applied to an uplink transmission;
determining at least one timing advance (TA) value for the at least one procedure; and
applying the at least one procedure to the uplink transmission by adjusting the timing of the uplink transmission based on the at least one TA value.

2. The method of claim 1, wherein the network device is coupled with a first TRP and a second TRP for communication with the terminal device, the first and second TRPs being included in the serving cell; and
wherein the first procedure is configured for adjusting timing of uplink transmissions via the first TRP and the second procedure is configured for adjusting timing of uplink transmissions via the second TRP.

3. The method of claim 1, wherein determining the at least one procedure comprises:
in response to receiving information on at least one resource associated with the uplink transmission, determining the at least one procedure based on the information.

4. The method of claim 1, wherein
determining at least one procedure comprises:
in response to receiving, from the network device, an indication of at least one SRS resource to be used for an uplink transmission over PUSCH, determining, based on the at least one SRS resource, the at least one procedure to be applied to the uplink transmission over PUSCH; and
adjusting the timing of the uplink transmission comprises:
adjusting the timing of the uplink transmission over PUSCH based on the at least one TA value.

5. The method of claim 1, wherein
determining at least one procedure comprises:
in response to receiving, from the network device, an indication of at least one DMRS port to be used for transmitting a DMRS associated with PUSCH, determining, based on the at least one DMRS port, the at least one procedure to be applied to an uplink transmission over PUSCH; and
adjusting the timing of the uplink transmission comprises:
adjusting the timing of the uplink transmission over PUSCH based on the at least one TA value.

6. The method of claim 1, wherein
determining at least one procedure comprises:
in response to receiving, from the network device, an indication of at least one CSI-RS resource for determining pre-coding information to be used for an uplink transmission over PUSCH, determining, based on the at least one CSI-RS resource, the at least one procedure to be applied to the uplink transmission over PUSCH; and
adjusting the timing of the uplink transmission comprises:
adjusting the timing of the uplink transmission over PUSCH based on the at least one TA value.

7. The method of claim 1, wherein
determining at least one procedure comprises:
in response to receiving, from the network device, a configuration for transmissions over PUCCH, determining, from the first and second procedures, a third procedure to be applied to an uplink transmission over PUSCH and a fourth procedure to be applied to an uplink transmission over PUCCH based on the configuration;
determining at least one TA value comprises:
determining a TA value for the third procedure and another TA value for the fourth procedure; and
adjusting the timing of the uplink transmission comprises:
adjusting the timing of the uplink transmission over PUSCH based on the TA value; and
adjusting the timing of the uplink transmission over PUCCH based on the other TA value.

8. The method of claim 2, wherein the at least one procedure includes the first procedure to be applied to a first uplink transmission via the first TRP,
determining at least one TA value comprises:
determining a first TA value for the first procedure; and
adjusting the timing of the uplink transmission comprises:
adjusting the timing of the first uplink transmission based on the first TA value.

9. The method of claim 8, wherein the at least one procedure further includes the second procedure to be applied to a second uplink transmission via the second TRP,
determining at least one TA value comprises:
determining a second TA value for the second procedure, the second TA value being different from the first TA value; and
adjusting the timing of the uplink transmission comprises:
adjusting the timing of the second uplink transmission based on the second TA value.

10. The method of claim 8, wherein the first TA value is determined based on at least one of the following:
a TA command from a Random Access Response;
a TA command from a Medium Access Control (MAC) Control Element (CE); and
a TA value determined for the first procedure previously.

11. The method of claim 9, wherein the second TA value is determined based on at least one of the following:
a TA command from a Random Access Response;
a TA command from a MAC CE;
a TA value determined for the first procedure previously;
a TA value determined for the second procedure previously; and
a timing difference between a first downlink signal received from the first TRP and a second downlink signal received from the second TRP.

12. A method implemented at a network device, comprising:
in response to the network device providing a serving cell to serve a terminal device and the serving cell being configured with at least a first procedure for adjusting timing of uplink transmissions and a second procedure for adjusting timing of uplink transmissions, determining, from the first and second procedures, at least one procedure to be applied to an uplink transmission; and
indicating the at least one procedure to the terminal device, such that the terminal device applies the at least one procedure to adjust timing of the uplink transmission.

13. The method of claim 12, wherein the network device is coupled with a first TRP and a second TRP for communication with the terminal device, the first and second TRPs being included in the serving cell; and
wherein the first procedure is configured for adjusting timing of uplink transmissions via the first TRP and the second procedure is configured for adjusting timing of uplink transmissions via the second TRP.

14. The method of claim 12, wherein indicating the at least one procedure comprises:
indicating the at least one procedure by transmitting, to the terminal device, information on at least one resource associated with the uplink transmission.

15. The method of claim 12, wherein
determining at least one procedure comprises:
determining at least one procedure to be applied to an uplink transmission over PUSCH; and
indicating the at least one procedure comprises:
indicating the at least one procedure by transmitting, to the terminal device, an indication of at least one SRS resource to be used for the uplink transmission over PUSCH.

16. The method of claim 12, wherein
determining at least one procedure comprises:
determining at least one procedure to be applied to an uplink transmission over PUSCH; and
indicating the at least one procedure comprises:
indicating the at least one procedure by transmitting, to the terminal device, an indication of at least one DMRS port to be used for transmitting a DMRS associated with PUSCH.

17. The method of claim 12, wherein
determining at least one procedure comprises:
determining at least one procedure to be applied to an uplink transmission over PUSCH; and
indicating the at least one procedure comprises:
indicating the at least one procedure by transmitting, to the terminal device, an indication of at least one CSI-RS resource for determining pre-coding information to be used for the uplink transmission over PUSCH.

18. The method of claim 12, wherein
determining at least one procedure comprises:
determining a third procedure to be applied to an uplink transmission over PUSCH and a fourth procedure to be applied to an uplink transmission over PUCCH; and
indicating the at least one procedure comprises:
indicating the third and fourth procedures by transmitting, to the terminal device, a configuration for transmissions over PUCCH.

19. The method of claim 12, further comprising:
transmitting a first TA command indicating a first TA value for the first procedure and a second TA command indicating a second TA value for the second procedure to the terminal device, such that the terminal device applies the at least one procedure to the uplink transmission by adjusting the timing of the uplink transmission based on at least one of the first and second TA values.

20. (canceled)

21. A terminal device comprising:
a processor; and
a memory coupled to the processor and storing instructions thereon, the instructions, when executed by the processor, causing the terminal device to:
in response to a network device providing a serving cell to serve the terminal device and the serving cell being configured with at least a first procedure for adjusting timing of uplink transmissions and a second procedure for adjusting timing of uplink transmissions, determine, from the first and second procedures, at least one procedure to be applied to an uplink transmission;
determine at least one timing advance (TA) value for the at least one procedure; and
apply the at least one procedure to the uplink transmission by adjusting the timing of the uplink transmission based on the at least one TA value.

22-24. (canceled)
